(19) United States
(12) Patent Application Publication
(10) Pub. No.: US 2007/0157432 A1
(43) Pub. Date: Jul. 12, 2007

(54) Magnetic hinge

(76) Inventor: Glenn Weinstein, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 11/330,025

(22) Filed: Jan. 11, 2006

(51) Int. Cl. E05D 11/10

(52) U.S. Cl. 16/320

(57) ABSTRACT

A hinge apparatus having a barrel region that include at least two magnets. The magnets are positioned within the barrel region to generate a continuously repulsive force relative to each other such that the weight of the door is supported at least partially by the magnetic forces generated by the magnets.

### BACKGROUND OF THE INVENTION

1. Field of the Invention

This invention relates generally to hinges for doors and the like and more particularly to hinges that include at least two magnets disposed such that the magnetic force generated thereby is load-bearing.

2. Description of the Related Art

There are three main types of door hinges: butt/mortise hinges, which are inset (usually in threes) into the door and frame; continuous hinges, which run the entire length of the door (also known as a “piano hinge”); and pivot hinges, which pivot in openings in the floor and the top of the door frame. Most commonly, lightweight interior doors of residential structures utilize butt/mortise hinges.

Over the years, hinges for doors of all types have evolved to provide better wear and desirable performance characteristics. Thus, for durability and quiet operation reasons, many hinge improvements have focused on the design, configuration, and lubrication of the hinge pin in relation to the large cylindrical barrel region (which often is made up of smaller cylinders known as “knuckles”). For example, hinges containing ball bearings are now commonplace. Moreover, convenience features, such as the ability to “self close,” have been created through the uses of springs and friction controls.

Some improved hinges also have involved the use of magnets. For example, European Patent EP0756056 discloses a hinge having magnets disposed around an aligning pin. The magnets are oriented such that their polarity produces an “attractive” magnetic force when the door is closed, which then gradually becomes a “repulsive” magnetic force as the door is opened. In other words, the particular polar arrangement of the magnets provides for an increasing “repulsive” orientation of the magnets as the hinge rotates open, thereby causing the door to be urged in the opposite direction (i.e., to the closed position). As such, the magnets simply act as a “self-close mechanism” and do not generate a magnetic force that would be weight or load bearing when the door is opened and closed.

U.S. Pat. No. 3,707,017 and U.S. Pat. No. 5,530,992 disclose a hinge that includes either a magnetic foil disposed within the aligning pin area or an aligning pin (or pin-receiving barrel structure) that is itself magnetic. However, in both patents, the magnetic material appears either to be disposed in such a way that it acts in a “latch-like” fashion to keep the door closed or in a coupling fashion such that magnets disposed on the door leaf of the hinge continuously attract the magnets disposed on the jamb leaf of the hinge. In other words, the magnets do not appear to be positioned to generate a magnetic force that is weight bearing during the opening and closing of the door.

Thus, it would be desirable to provide a magnetic hinge that reduces friction by utilizing magnetic forces for load bearing and that can be attached to or integrated with a variety of doors.

### SUMMARY OF THE INVENTION

The invention relates in general to a hinge that includes at least two magnets or magnetic surfaces in the cylindrical “barrel” region of the hinge. The magnets possess a polarity, and are positioned, such that they generate a continuously repulsive force relative to each other (i.e., they do not magnetically attract each other). Therefore, the magnets are disposed such that the magnetic force generated is load-bearing. Accordingly, the invention provides a hinge that has little (or less) friction between moving parts, thereby improving the ease of opening and the performance characteristics (e.g., noise level) of the door.

In one aspect of the invention, the hinge includes at least two annular magnets or magnetic surfaces that are disposed upon a bottom of one knuckle and the top of another knuckle in the barrel region of the hinge and have an aligning structure (such as a pin) running the length of the barrel region.

In another aspect of the invention, the hinge includes at least two magnetic knuckles in the cylindrical barrel region of the hinge. The polarity of the magnetic knuckles is such that they generate a continuously repulsive force relative to each other (e.g., one magnetic knuckle has a polarity from top to bottom of north to south, while a second magnetic knuckle below the first has a polarity from top to bottom of south to north). Therefore, the magnets are disposed such that the magnetic force generated is one of continuous repulsion. The knuckles of this embodiment may be held in alignment with a pin that only runs part of the length of the barrel region.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 depicts a front elevational view of a first embodiment of the invention.

FIG. 2 shows a top plan view of the embodiment shown in FIG. 1.

FIG. 3 illustrates a cross-sectional view of the embodiment shown in FIG. 2 as taken along line 3-3.

FIG. 4 is a front elevational view of a second embodiment of the invention.

FIG. 5 is a front elevational view of a third embodiment of the invention.

### DETAILED DESCRIPTION OF THE PREFERRED EMBODIMENTS

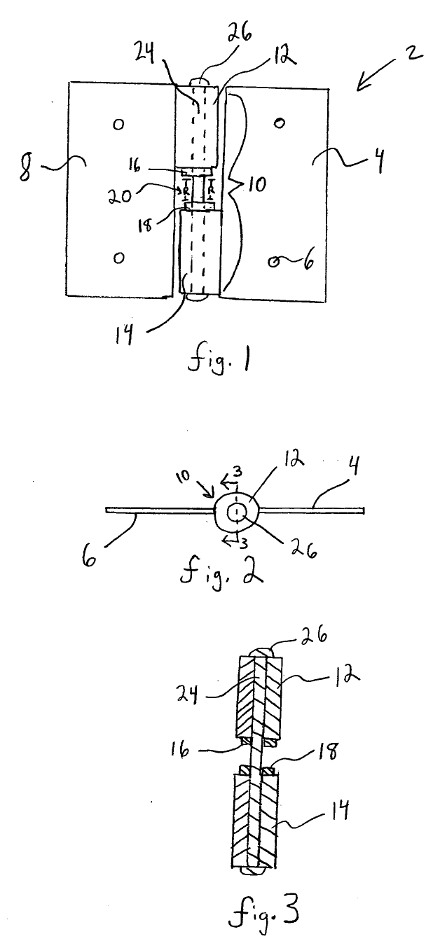

Turning to FIG. 1, the invention generally relates to a hinge 2 having a first leaf 4, which is mounted to a door jamb (not shown) with fasteners installed through holes 6, and a second leaf 8 that is mounted on a door (not shown). The barrel region 10 of this embodiment of the hinge 2 is made up of knuckle 12 and knuckle 14. Knuckles 12 and 14 are attached to or continuous with leaves 8 and 4, respectively.

Disposed at the bottom of knuckle 12 is an annular magnet 16 having a first top-to-bottom polarity. Likewise, disposed at the top of knuckle 14 is an annular magnet 18 having a second top-to-bottom polarity that is the opposite of the polarity of magnet 16. For example, if magnet 16 is disposed with a polarity of “north” at the top end (coupled with knuckle 12) and “south” at the bottom end, then magnet 18 will have a polarity that is “south” at its top end (the end closest to magnet 16) and “north” at its bottom end. In this manner the magnets 16 and 18 generate a continuously repulsive magnetic force designated by the letters R at the end of arrow 20.

Of course, the natural tendency of two or more magnets that are positioned as described above and pictured in FIG. 1 is to be urged away from each other. However, the movement caused by repulsive magnetic force 20 is stopped by alignment pin 24 having an end cap 26. In addition to keeping knuckles 12 and 14 from being urged away from each other, the alignment pin 24 provides a pivot and keeps the barrel region 10 in axial alignment so that a door will not come off its hinges during rotation if the door is pulled in a direction away from its hinges. Thus, the load that the door places on knuckle 12 is at least partially born by the magnetic force 20, thereby reducing friction and the wear and noise caused by friction.

As seen in FIG. 2, the hinge 2 is of a common configuration in that the leaves 4 and 6 are generally planer and the barrel 10 is cylindrical. Thus, the invention may be utilized with existing hinges by retrofitting (or replacing) knuckles such that a continuously repulsive magnetic force is generated axially. Depending upon the weight of the door, small magnets of sufficient Gauss strength are used and preferably include strong rare-earth magnets.

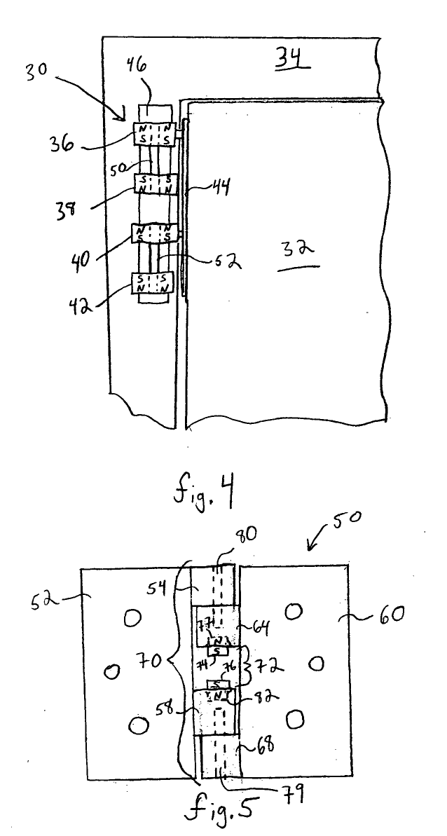

FIG. 3 depicts a cross-sectional view of FIG. 2 as taken along line 3-3 and viewed in the direction indicated by the arrows. The structure and arrangement of the annular magnets 16 and 18, as well as that of the alignment pin 24, are more clearly seen in this view.

Turning to FIG. 4, a second embodiment of the invention is depicted. Hinge 30 is disposed such that the weight of door 32 is at least partially supported within doorjamb 34 through magnets 36, 38, 40, and 42, which are arranged with the polarities as shown so that each magnet repels those in proximity thereto. In this embodiment, each knuckle is a magnet. Thus, magnets 36 and 40 are coupled to the door leaf 44, while magnets 38 and 42 are coupled to jamb leaf 46. Although other arrangements are possible, this particular configuration assures that the magnetic repulsion force provides a “lifting” action upon which door 32 at least partially rests. Alignment pin 50 keep magnets 36 and 38 in axial alignment, while pin 52 keeps magnets 40 and 42 similarly aligned.

FIG. 5 depicts an embodiment of the invention that features a standard four-inch hinge 50 that has had the center knuckle removed to define a central space that accommodates the magnets of the invention. The complete hinge 50 includes a jamb-mounting leaf 52 that is coupled to knuckles 54 and 58 and door-mounting leaf 60 that coupled to knuckles 64 and 68. When interposed as shown, the knuckles of the door-mounting leaf 60 and said jamb-mounting leaf 52 define a barrel 70 with a center space 72 that is formed by virtue of the removed center knuckle (not shown).

Knuckle 64 from the door-mounting leaf 60 is positioned above center space 72, while knuckle 58 from the jamb-mounting leaf 52 is positioned below the center space. Thus, a magnet 74 that is disposed upon the bottom of knuckle 64 and a magnet 76 that is disposed upon the top of knuckle 58 below will create a repulsive magnetic force between knuckles 58 and 64 and within the center space 72 when the polarity of each magnet (e.g., south pole to south pole) is positioned as shown. In this manner, a repulsive magnetic force of sufficient strength will at least partially support the weight of the door. While magnets 74 and 76 are shown disposed in recesses 77 and 79, respectively, the magnets could also be adhered or otherwise coupled to each knuckle.

At the upper and the lower end of the barrel 70 are alignment means 80 and 82. Although the alignment means take the form of pins in this embodiment, the inventor anticipates that other alignment means can be used between knuckles, such as bearings, coupling collars, and the like. The alignment means 80 and 82 are disposed through an opening and channels extending completely through knuckles 54 and 68 and partially through knuckles 58 and 64.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. An apparatus, comprising:
a hinge having a barrel region defining an axis around which said hinge pivots, said barrel region including at least two magnets, wherein said at least two magnets are positioned within the barrel region to produce a continuously repulsive magnetic force relative to each other along said axis.

2. The apparatus of claim 1, wherein said magnets are annular.

3. The apparatus of claim 1, wherein said magnets comprise knuckles in the barrel region.

4. The apparatus of claim 1, further comprising a recess disposed in a knuckle and adapted to accommodate at least one of said at least two magnets.

5. The apparatus of claim 1, further including an alignment pin disposed through said magnets.

6. The apparatus of claim 1, wherein said magnets are disposed such that said repulsive magnetic force generated thereby is load-bearing.

7. An apparatus for hinging two objects together, comprising:
a first leaf coupled to at least one knuckle,
a second leaf coupled to at least one knuckle,
a magnet disposed upon at least two of said knuckles, said magnets disposed such that polarity of a first magnet is opposite to that of a second magnet such that the magnetic force generated thereby is continuously repulsive; and
an alignment means disposed within an opening in said knuckles.

8. The apparatus of claim 7, wherein at least one of said magnets is annular.

9. The apparatus of claim 7, wherein said magnets comprise knuckles.

10. The apparatus of claim 8, wherein said alignment means are axially disposed through at least one of said magnets.

11. The apparatus of claim 10, wherein said alignment means comprises an alignment pin.

12. A hinge apparatus, comprising:
a door-mounting leaf coupled to at least two knuckles,
a jamb-mounting leaf coupled to at least two knuckles, said knuckles of said door-mounting leaf and said jamb-mounting leaf being adapted to define a barrel with a center space devoid of knuckles when said knuckles are interposed, and wherein a knuckle from the door-mounting leaf is positioned above said center space and a knuckle from the jamb-mounting leaf is positioned below said center space,
a magnet disposed upon a bottom of said knuckle above the center space and a magnet disposed upon a top of said knuckle below said center space, said magnets disposed such that a continuously repulsive magnetic force exists therebetween; and
at least two alignment means disposed through an opening in said knuckles and extending axially therethrough.

13. The apparatus of claim 12, wherein said at least two alignment means are located at a bottom and a top of said barrel and pass entirely through one knuckle and partially through a second knuckle.
